(19) United States
(12) Patent Application Publication
(10) Pub. No.: US 2020/0046459 A1
(43) Pub. Date: Feb. 13, 2020

(54) REAL-TIME GUTTA PERCHA (GP) FLOW FOR ROOT CANAL THERAPY (RCT) IN ENDODONTICS DENTISTRY

(71) Applicant: THE UNIVERSITY OF HONG KONG, Hong Kong (CN)

(72) Inventors: Tze Chuen NG, Hong Kong (CN); Chengfei ZHANG, Hong Kong (CN)

(73) Assignee: THE UNIVERSITY OF HONG KONG, Hong Kong (CN)

(21) Appl. No.: 16/655,590

(22) Filed: Oct. 17, 2019

Related U.S. Application Data
(63) Continuation-in-part of application No. PCT/IB2018/052641, filed on Apr. 17, 2018.
(60) Provisional application No. 62/486,301, filed on Apr. 17, 2017.

(51) Int. Cl. A61C 5/55

(52) U.S. Cl. CPC A61C 5/55; A61C 2201/007; A61C 2201/005

(57) ABSTRACT

Channels in a root canal of a decayed tooth are scaled with a Gutta Percha (GP) mini pellet located at the apical tip of the channel and tubular GP at the side channels. Thermostatic heat and/or ultrasonic vibration can be applied during placement. Further, real time x-rays can be taken to guide the placement and even to at least in part automate the process.

### CROSS-REFERENCE TO RELATED APPLICATIONS

This application is a U.S. continuation-in-part of International Patent Application No. PCT/IB2018/052641 filed on Apr. 17, 2018 and claims the benefit of priority to U.S. Provisional Application Ser. No. 62/486,301 filed Apr. 17, 2017, the contents of both of which are incorporated herein by reference. The International Application was published in English on Oct. 25, 2018 as WO 2018/193362 under PCT Article 21(2).

### FIELD OF THE INVENTION

The present invention relates to endodontics in dentistry or root canal therapy and, more particularly, to the accurate sealing of the apex of the root canal of a tooth.

### BACKGROUND OF THE INVENTION

Every tooth has a pulp chamber with blood vessels, lymphatic tissue and nerves to support its well-being. Due to decay, trauma or other factors, the pulpal chamber may become infected and pathological lesions can develop. Endodontics involves the procedures and instruments needed to clean and disinfect the pulpal chamber, enlarge the root canals in the tooth and the placement of rubbery Gutta Percha (GP) material filaments to close all the apical and side canals. The stages of a root canal procedure are shown in FIG. 1.

The typical handling of root canals during endodontics involves applying local anesthesia to the patient to numb the nerves of the involved tooth. The infected tissue is removed, e.g., using a set of broaches, i.e., a barbed instrument used to remove pulp tissue during endodontic (root canal) treatment. It is manufactured from round wires where the smooth surface has been notched to form barbs. The canals and pulp chamber are prepared with special reamers and files (dental tools), dried and followed by placement of medication and temporary cement in the tooth to temporary seal it.

In a final appointment, GP is used to fill the hollow root canals of the tooth without voids. In particular, GP is used to fill the root canal to its apex, and exactly to the apex of the root. High precision is required (e.g., within 0.5 mm). The difficulty with current GP placement is that the GP material is weak and flexible so that during the placement of the GP it may bend especially under heat. This makes it difficult to fit the GP into narrow curved root canals.

The sealing procedure conventionally uses a number of GP filaments to fill the canal. In particular, the latest procedure uses a large amount of GP coated on a flexible filler called Thermafil and it is applied under heat. As a result, the GP can overshoot at the apex, i.e. pass out of the opening at the apex and spread beyond the root canal to the periphery below the root. The overshooting of GP can cause severe problems, such as neural and pathological complications.

The prior conventional procedures using GP root sealing material that has only one geometry (filament) cannot adequately deal with the different directions of the void spaces in the root canal. Also, using standard tools is too time consuming. The mere changing of tools by the endodontist during the procedure takes time unnecessary. Further, using single function tools or hand pieces cannot cope with different direction vibratory motions necessary for effectively delivering the material. As a result, there is a need to custom design a hand piece with different direction vibratory motions and thermostatic heat control to speed up the process. Further, no computer has been adopted by Endodontics and no means has been provided in the prior art for viewing in real time the flow of GP sealing material during sealing in a root canal procedure. Without being able to visualize the flow the practitioner is left to blind insertion, which can lead to unpredictable results.

In addition, the prior procedures and instruments cannot control the flow of sealing material. Further, the prior art provides no protocol for building the foundation before crowning of the tooth and there are no predictable result for micro canal terminus.

### SUMMARY OF THE INVENTION

The present invention is directed to a new procedure, optionally using new instruments, to place Gutta Percha (GP) so as to seal the tooth root canals at the apical end (apex) of the main canal and at the terminal points of the side canals. The invention includes the use of a small pellet of GP for sealing the apical end of the main canal called “A-GP” (Apical-GP), and a tubular or collar form of GP for sealing the side canals called “T-GP” (Tubular GP), both mount on Nickel Titanium (Nitinol)metallic filler.

The insertion of the two forms of GP on the metallic filler can be accomplished with a hand piece that provides thermostatic heat and ultrasonic vibration. In the case of a remote-controlled device called a “Dome”, where the endodontist is located at a safe distance next door, a digital pulse interval X-ray transmitter pointing to an x-ray receiver mounted on the side of the Dome. This may be part of a multi-functional plastic holder for mounting a mini thermostatic heater and mini vibrator along with a mini linear actuator to fit on top of the metallic filler for pushing the heated vibrating GP into the terminus which real-time monitoring of its flow through computer next door. The pulse interval x-ray reduces the amount of x-ray radiation received by the patient.

The process of the present invention is carried out in two major stages: (1) sealing the apex using the A-GP pellet (which is approximately 2 mm in length) (2) sealing the side canals using the T-GP. With the use of the GP pellet (small amount of GP), endodontists can avoid the issues of overshooting the apex. Also, using the thin nickel titanium flexible filler can help endodontists reach the apex of the narrow and curved root canal for sealing, i.e. “spot sealing”. The endodontists can tackle multiple mini canals in a single root apex delta with step-by-step insertion of two or three A-GP pellets. This two stage or step process solves all of the post-operative complication problem that result from unfilled micro-void spaces, e.g., abscess, granuloma, cystic lesion.

After applying the A-GP, the main apex is sealed and overshooting can no longer occur. Applying the T-GP using heat and vibration can then fill up all the side canals. The two-step sealing process solves all of the post-operative complication problems that arise from unfilled micro void spaces e.g. abscess, granuloma, and cystic lesions. The process is made more precise by using the A-GP pellet structure for sealing the apex and the T-GP tube structure for sealing the side canals under exact heat temperature and ultrasonic vibratory magnitude control.

The invention involves a filler made of Nickel Titanium NiTi (nitinol), which can conduct heat and vibration to the GP for sealing. The filler is operated by the custom designed handpiece, which includes preset thermostatic heat and vibratory magnitude to control the temperature and vibration.

In another configuration, the real time x-ray imaging can be used to provide a robot-assisted application with remote control. The endodontist can use a computer to control the real time GP flow imaging by asking the patients to bite on a custom designed x-ray holder. The endodontist can then sit inside a monitor room to avoid the x-ray radiation and look at the monitor. Then based on the monitor images, control the movement of the GP by activating a linear actuator device remotely. Further the endodontist can control the heat and ultrasonic vibration applied to the filler. As part of the computer control, a finishing stop can be used in the software to plot the desired finishing line on the screen to stop the actuator at a point where the GP flow takes into account the volumetric shrinkage of GP, so that the GP is located accurately at the apex after the heat has dissipated.

With the present invention the dentist can, for the first time in Endodontics, determine the exact temperature and vibratory force magnitude to control the GP flow in order to reach the terminus points. The endodontists can see real time GP flow on a computer monitor due to the opacity of GP motion along the canal pathway.

Endodontists can clean and enlarge the canal faster and more efficiently by merging all of the preparation tools into a single tool, referred to as a hybrid reamer—file called an “RF Hybrid.” Further, the endodontist can dry and clean the canal more efficiently by using a spiral threading tool working clockwise for drying by creating a helical spiral of hot current leading out of the canal same as tornado current, and counterclockwise for cleaning by creating current downward pushing the debridement liquid into micro canals to dissolve and clean the residual pulpal tissue still inside.

By using the present invention, the strongest structure can be built for supporting a crown with nitinol fillers left in situ forming a root canals tripod, screw anchorage posts against canal walls as concrete vertical extensions, and an amalgam core on top of the structure.

In addition to common root canal procedures, the present invention can be used in the rare case of a C section uni-canal molar. In particular, the endodontist can seal special C Section uni-canal tooth by a custom designed C section A-GP & T-GP carried by a custom designed C section ultrasonic/thermal (UT) filler. It is for very occasional patients just in case.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1 illustrates the steps in a root canal procedure;

a series of FIG. 2 is an illustration of an optional thermal conduction broach for removing coagulated intact pulpal tissue;

FIG. 3A is a side view of a first embodiment of a hybrid reamer-file (R-F hybrid) useful in cleaning and enlarging the root canal channel of a tooth, and FIG. 3B is a cross sectional view thereof;

FIG. 4 is a schematic illustration of a cross section of the R-F hybrid showing the reamer and file surfaces in one tool;

FIG. 5 is an illustration of the effect of vertical and side ultrasonic vibration of the R-F hybrid, abrasive motion of the cross section circular tool against the oval shape of a root canal;

FIG. 6 is an elevation view of a second embodiment of a hybrid reamer-file illustrating the effect of vertical and side ultrasonic vibration for filing and reaming;

FIG. 7 is an elevation view of a cleaner-dryer tool activated by Ultrasonic vibration for use in a root canal during cleaning with sodium hypochlorite for debridement;

FIG. 8 is a view of the cleaner-dryer tool of FIG. 6 during drying;

FIG. 9 is a view of a Tornado Ni Ti cleaner tool showing the effect of a passive helical spiral indent in creating the Tornado effect;

FIG. 10 is a side view of a nitinol filler for providing an A-GP mini pellet at the apical tip of a root canal with thermostatic heat and ultrasonic vibration;

FIG. 11 shows the apical end of a root canal delta with three channels, each of which is sealed with an individual A-GP pellet;

FIG. 12 is an illustration of a nitinol filler installing a tubular or collar GP (T-GP) during application of thermostatic heat and ultrasonic vibration;

FIG. 13A shows a NiTinol filler with a median neck portion (isthmus design), FIG. 13B shows the filler of FIG. 13A located in a root canal and placing an A-GP pellet, FIG. 13C shows the neck of the filler being broken to separate a lower portion from an upper portion, FIG. 13D shows the upper with a T-GP sleeve applied, and FIG. 13E shows T-GP being placed into side channels;

FIG. 14A is an illustration of a C section ultrasonic/thermal filler, FIG. 14B is an illustration of a C section uni-canal tooth in which the GP can be installed at collar called CT-GP, and FIG. 14C is a C section of GP that can be used at the apical end of the tooth canal called CA-GP;

FIG. 15 is an illustration of a nitinol filler with a Teflon tip coating or ultra smooth surface for easy detachment, supporting a snap on A-GP mini pellet;

FIG. 16A shows a Ni Ti filler for installing an A-GP with an ultra-smooth tip, FIG. 14B shows the tip of FIG. 16A with a Teflon coating, FIG. 16C shows the Teflon tip of FIG. 16B with an A-GP pellet, FIG. 16D shows the tip of FIG. 16A with T-GP material installed;

FIG. 16G shows a Ni Ti filler for installing a C section filler with an ultra-smooth tip, FIG. 16H shows the tip of FIG. 16G with a Teflon coating, FIG. 16E shows the tip of FIG. 16H with an A-GP for a C section, and FIG. 16F shows the tip of FIG. 16G with T-GP material;

FIG. 17A shows a metallic condenser with woodpecker teeth with ultra smooth tip using ultrasonic vibration and thermostatic heat to install a T-GP and an A-GP, FIG. 17B is an enlarged view of the tip from FIG. 17A and FIG. 17C is a further enlarged view of the side showing GP forced into a side canal. The woodpecker design is simulating the motion of the hammering beak 20 forcing the T-GP into the micro side canal;

FIG. 18A illustrates the tip of a filler with A-GP sealing the apical canal, FIG. 18B shows the T-GP being forced into a side channel;

FIG. 19 is a view of a tip with a smooth non-stick surface and an A-GP pellet mounted on it, with thermostatic heat and ultrasonic vibration;

FIG. 20A shows a side view of an anchorage screw post inserted into the metallic filler installed by hexagonal screw driver on top of the canal to build up a platform for a crown, FIG. 20B shows a cross sectional view at line B-B with a hexagonal screw driver installed, and FIG. 20C shows a cross sectional view at line C-C showing the threading anchorage against canal wall;

FIG. 21 shows the top and FIG. 22 shows the bottom of an assemblage of the nitinol filler, and the anchor screw post with T-GP and A-GP below;

FIG. 23 shows the shape of the nitinol filler with different kinds and sizes of GP located on it, i.e., A-GP and T-GP;

FIG. 24 is a top view of the anchor screw post mounted with a hexagonal screw driver;

FIG. 25 is a perspective view of the anchor screw post and hexagonal screw driver;

FIG. 26 shows a tripod structure with anchorage screw posts connected to the nitinol filler and an amalgam core supporting a crown to establish a strong structural framework for the non-vital tooth;

FIG. 27 shows a profile view of an assemblage of a tool for performing a root canal procedure with a digital x-ray guider and receiver attached so as to provide real time images as the two kind of GPs are installed in a root canal;

FIG. 28 is an enlarged view of FIG. 27, but with a molar having three apical tips with one being sealed while x-ray images are taken. Multiple rooted can be operated simultaneously with multi sets with same principle;

FIG. 29 is an illustration of a computer monitor showing the real time images available during sealing of the apex and side channels of the root canal, with control of the temperature, ultrasonic vibration and the linear motion by linear actuator;

FIG. 30, shows the linear actuator in various states during placement of GP as well as control of temperature and ultrasonic vibration;

FIG. 31 illustrates a computer monitor in which an image of a stop line is provided which accounts for the shrinkage of the A-GP after placement, and which can be used to trigger the automatic stopping of the linear actuator so as to accurately place the A-GP;

FIG. 32 shows an assemblage of the handpiece for placing a nitinol filler, T-GP and A-GP, wherein the tool has heat and ultrasonic vibration controls;

FIG. 33 shows the assemblage of FIG. 32, further being rotated to show the digital x-ray guider and receiver, and including a tooth clamp;

FIG. 34 shows the Dome can be fitted on the two holes of existing Rubber Dam Clamp for anchorage, can act as a protecting cover against accidental closure of opposing dentition, and even creating downward repulsive magnetic force to push the GPs down to the targets if mounted with EMC (Electrode Magnetic Coiling).

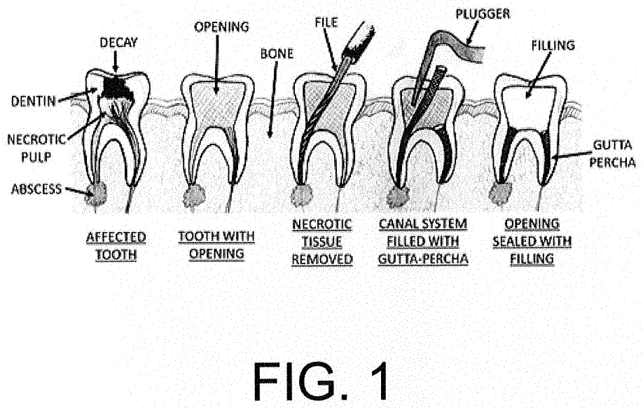

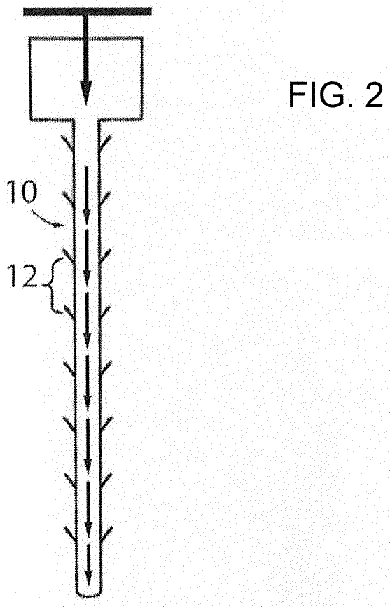

### DETAILED DESCRIPTION OF THE INVENTION

The present invention relates to improved methods, materials and instruments for sealing root canals in Endodontics. When due to decay, trauma or other factors, the pulpal chamber of a tooth becomes infected and pathological lesions develop, endodontics treatment is applied. The first step involves applying local anesthesia to the patient to numb the nerves of the involved tooth. Then the next step is the cleaning and disinfecting of the pulpal chamber.

FIG. 2 shows a broach for removing pulpal tissue. A broach is an instrument 10 with barbs 12 pointing at 45° upward for engaging the pulpal tissue and pulling it from the root chamber or canal. The particular broach shown in FIG. 2 can be made of Nickel Titanium (nitinol) and is capable of transmitting heat from the proximal end to the barbs, i.e., thermal conduction, so as to “cook” the pulpal tissue. This aids in the removal of the tissue intact in a single piece in a coagulated state. Adding thermal heat is optional.

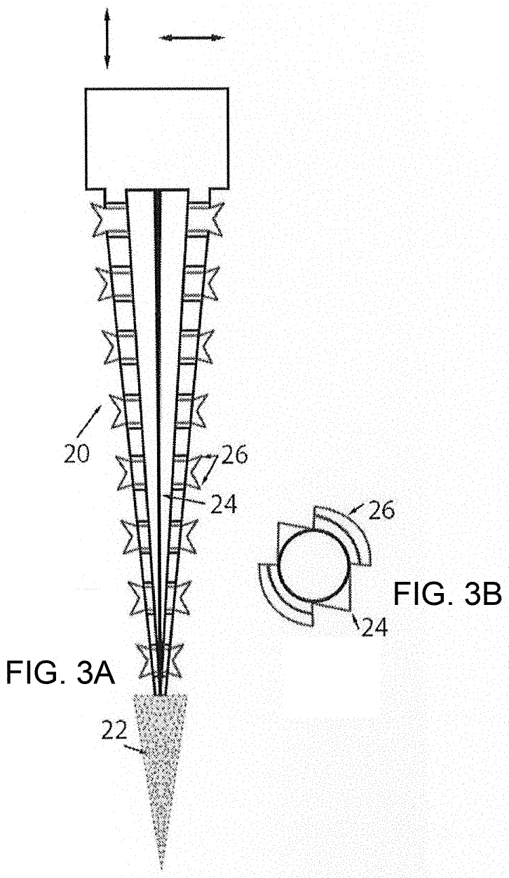

A next step in endodontics is to enlarge the canals in the tooth. This is achieved with various tools such as files and reamers. FIG. 3A shows a hybrid reamer-file (R-F hybrid) 20 useful in cleaning and enlarging the root canal of a tooth. This tool has a tapered shape with a fine diamond coated file 22 at its apical end deliberately designed to create micro roughness for future A-GP retention. More proximally, the R-F hybrid has a series of ever wider horizontal blade files 26 on upper and lower levels. It also has vertical blade reamers 24. As shown in the cross section of FIG. 3B, the vertical reamer blades 24 are on opposite sides of the hybrid and have points that engage the chamber wall. The horizontal blades 26 are at 90° to the vertical blades 24 and have curved sections that scrape an area of the chamber wall. Inverted horizontal blades are functional when the tool is going up and down due to vertical ultrasonic motion.

The cutting-edge geometry of the hybrid creates a reasonably smooth entry passageway for an ultrasonic-thermal (UT) filler carrying the GP. The diamond abrasive tail 22 in the lower portion of the hybrid is for creating micro retention for A-GP & CA-GP. The benefit of the hybrid is that it reduces the time the dentist needs to spend changing instruments during endodontic procedures. With the present inventive, there is no need to enlarge the canal too much as long as the smallest size UTF carrying the GPs can reach the bottom.

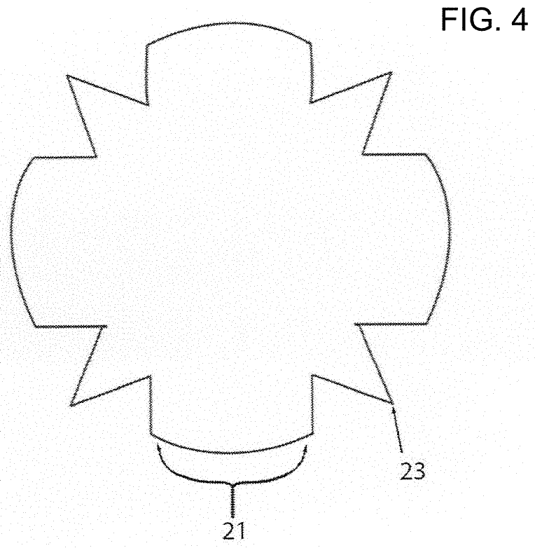

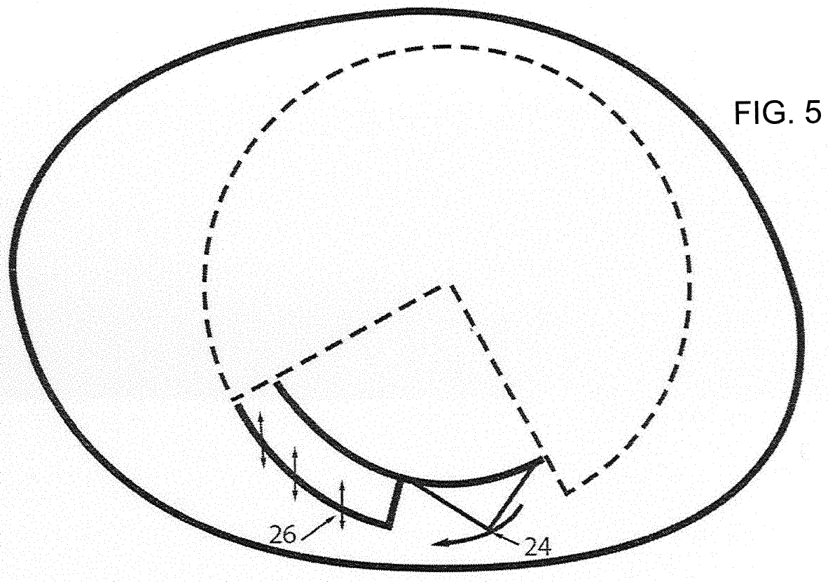

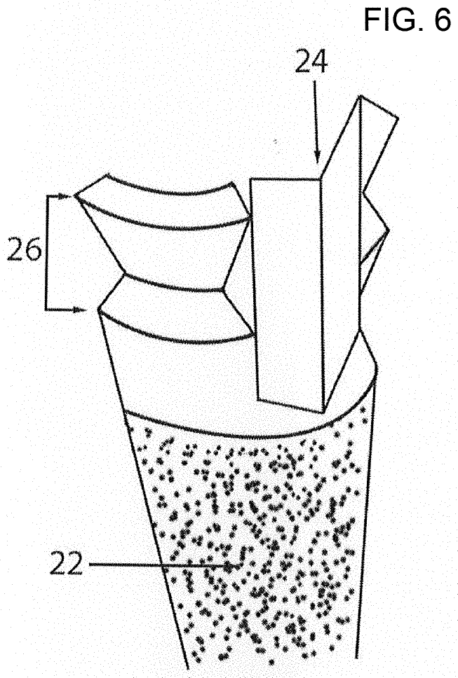

The R-F hybrid can be subject to vertical ultrasonic vibration from a tool engaged with the proximal end of the hybrid. Since the chamber typically has an oval cross section and the tool has a round cross section, to contact the entire wall surface the tool is manually moved in a great circle. FIG. 4 is a schematic illustration of a cross section of the R-F hybrid showing the filing surface 21 and reaming surface 23. An enlarged view is shown in FIG. 5 which shows the relationship between the vertical ultrasonic vibration and the great circle manual movement. Also, a waste channel 26 between the file and the reamer is shown through which debris from the action of the R-F hybrid against the chamber walls may pass. A perspective view of the R-F hybrid is shown in FIG. 6. Thus, the hybrid tool merges the design features of a reamer, file, and diamond abrasive tail.

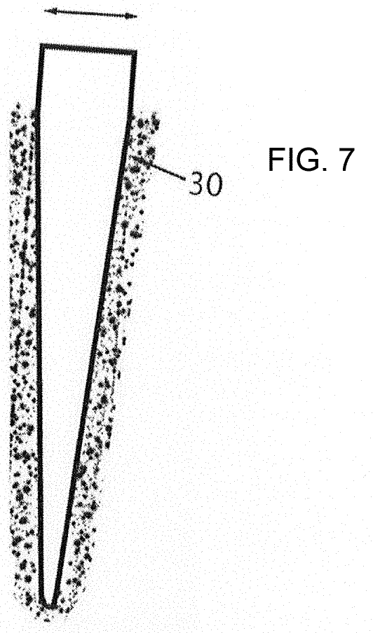

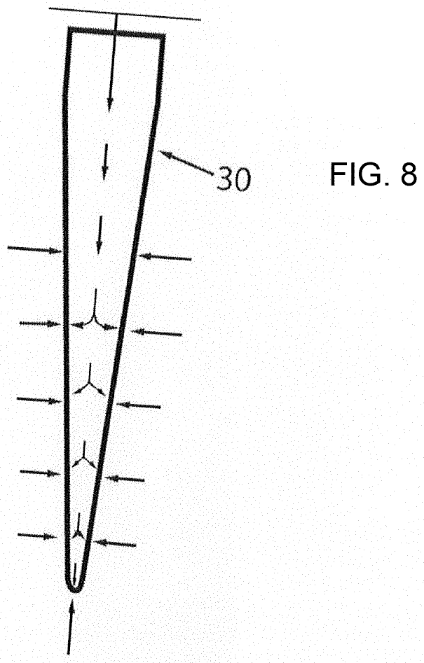

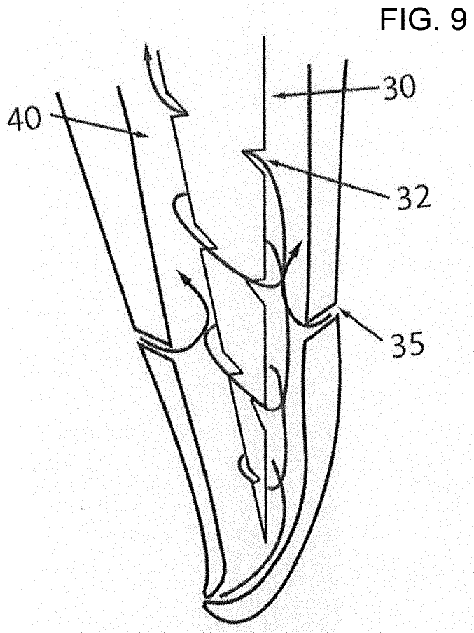

A further step in the preparation of the chamber involves cleaning with sodium hypochlorite solution. FIG. 7 shows a tool 30 which allows the distribution of this solution throughout the cavity. As shown in FIG. 8, this tool 30 can also be used to dry the chamber. As better shown in FIG. 9, the cleaning and drying can be accomplished by rotating the tool 30 in the clockwise direction and then reversing the rotation to the counterclockwise direction. In particular, a nitinol metal tool 30 is shown located within the chamber 40. The tool has spiral grooves 32 in it, such that when it is rotated in a counterclockwise direction, the flow of sodium hypochlorite solution is directed downward into the chamber so as to exit from the apical end and side channels 35. The effect of the sodium hypochlorite solution is to dissolve the residual minute pulpal tissue in the root canal.

When the tool is rotated in the clockwise direction, it pumps the solution upward and out of the chamber. This not only sucks the solution out of the chamber, it draws excess solution surrounding the chamber out of the top. In effect, the rotation creates a wind draft like a tornado to dry the chamber. Hot air can also be forced into the chamber around the tool during this process to help with the drying when a thermostat heater is on.

Once the chamber has had the pulpy tissue removed, has been widened, cleaned and dried, it is ready to be sealed. This involves the placement of rubbery Gutta Percha (GP) material filaments within the chamber such as to close all the apical and side channels. Then the chamber is completely filled.

The first step in the sealing process is to obtain a nitinol metallic filler. This material exhibits high tensile strength and shape memory. Shape memory is the ability of nitinol to undergo deformation and then recover its original, un-deformed shape.

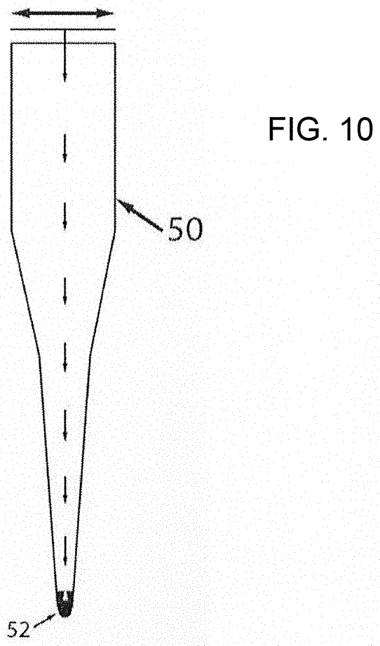

A nitinol metallic filler can curve as it is inserted into the root canal. As shown in FIG. 10, this NiTi filler 50 can have a GP pellet 52 located at its distal end. In particular, the A-GP pellet is used to fill the root canal to its apex, and exactly to the apex of the root. High precision is required (e.g., within 0.5 mm). The GP material under heat and the nitinol filler are flexible so that during the placement of the GP pellet they may bend according to the curvature of root canal.

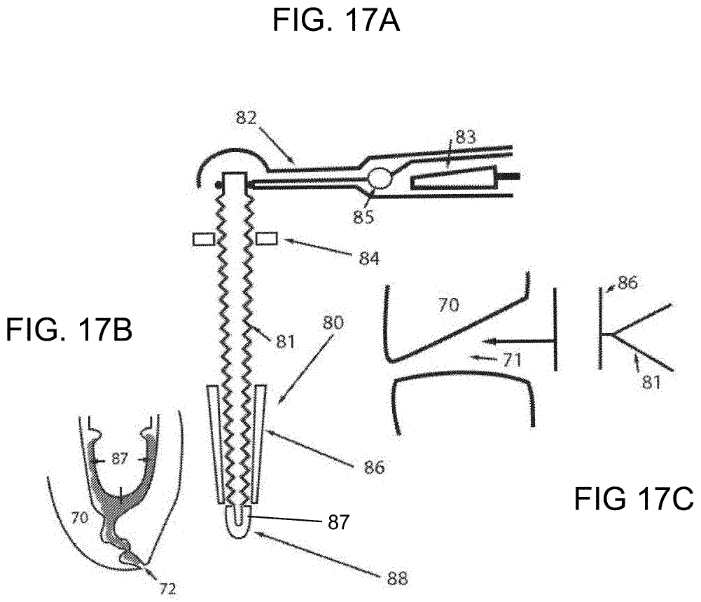

The filler 50 as shown in FIG. 10 may have heat applied to it (dashed arrows) and may also be subject to ultrasonic vibrations (single arrow). Since the nitinol filler is conductive, the heat and vibration energies are carried down to the tip of the filler, so it engages the GP at the tip and causes it to undergo amorphous deformation and to flow. This real time GP flow fills the opening at the apical tip and seals it. This flow is best created by an exact temperature set by thermal heat, and an exact magnitude and frequency of vibration set by an ultrasonic vibrator from a tool engaged with the proximal end of the filler, e.g., the tool 82 shown in FIG. 17A.

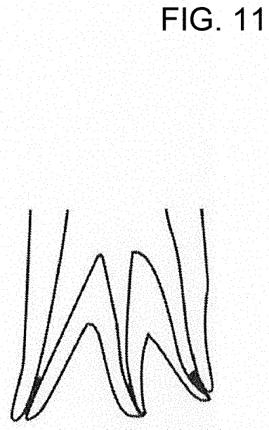

While with conventional sealing procedures a practitioner can overshoot in placing the heated large volume of GP at the apex of the canal (e.g. Thermafil), because of the small size of the A-GP pellet according to the present invention, the likelihood of an overshoot is minimized. As shown in FIG. 11, some teeth, e.g., molars, can have more than one apical opening that must be sealed. In such a case, when one pellet is placed, the filler is withdrawn, and a second pellet is installed at the distal end. Then it is re-inserted and guided to the second apical tip. This is repeated as necessary. A Teflon coating or ultra smooth surface can be provided on the tip to assure that the heated GP does not stick to it.

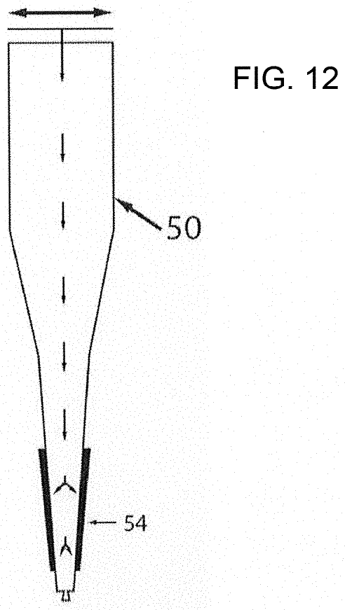

As a next step, once the apical tips are sealed with GP pellets, the NiTi filler is withdrawn again. This time a tubular or collar shaped piece of T-GP 54 is placed around it. It is located on the middle to lower end of the filler 50 so that when installed in the canal, the piece 54 will be at the location of the side canals. By injecting heat into the filler as shown by the arrows in FIG. 12, the tubular GP (T-GP) melts and flows into the side canals sealing them. During the process, the filler can be ultrasonically vibrated from side to side to help seat the T-GP in the side canals.

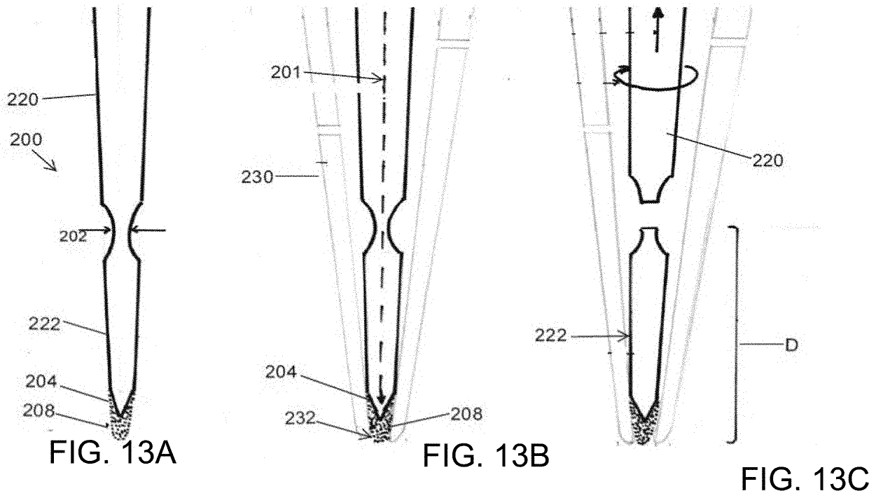

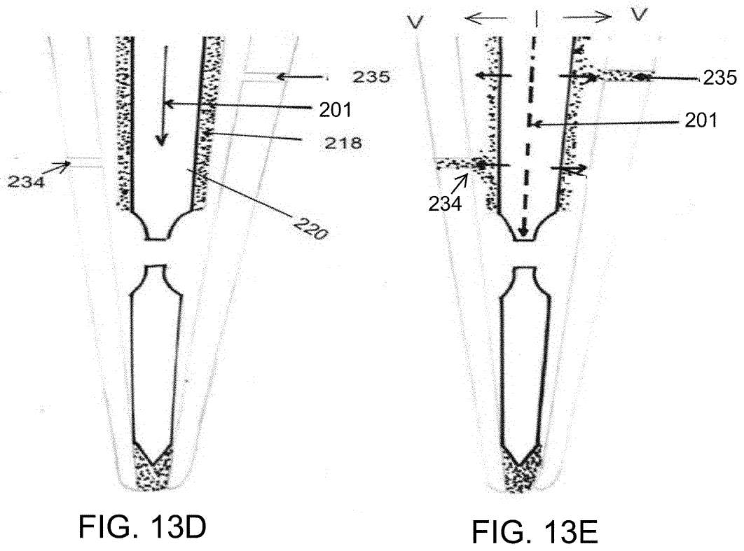

A particularly preferred embodiment of a NiTinol filler 200 is shown in FIG. 13A. The filler has a generally tapered shape from its proximal to its distal end. At about the midpoint the filler has necked down portion 202 so that it has an isthmus shape with a top part 220 and a bottom part 222. There is a sharp tip 204 at its distal end where an A-GP pellet 208 may be mounted. As shown in FIG. 13B the filler 200 may be located in a root canal 230. FIG. 13B shows the filler 200 placing the A-GP pellet 208 at the base or apex 232 of the canal. When in that position, thermostatic heat is conducted down the filler (arrow 201) to the tip 204 so as to melt the GP and seal the apex of the canal. The heat is removed, and the GP is allowed to cool. When the GP has solidified, the upper part 220 of the filler is rotated to break the filler at its neck or isthmus 202 as shown in FIG. 13C. This separates the filler into to a separate lower part 222 and an upper part 220.

Next the upper portion 220 is withdrawn from the root canal as indicated by the arrow, while the lower portion 222 is left in place. The depth coverage D of the lower portion is about 10% of the root canal height. The upper portion 220 is next provided with a T-GP sleeve 218 and is reinserted into the root canal at about the depth of a side canal or canals 234, 235 as shown in FIG. 13D. Thermostatic heat 201 is again applied to the filler. This time only to upper portion 220. At the same time lateral ultrasonic vibration is applied to the upper portion as indicated by the lateral arrows V. The result is that the GP melts and flows laterally into the side canal(s) 234, 235 as shown in FIG. 13E. When complete the heat and vibration are removed, and the upper portion is left in place in the root canal.

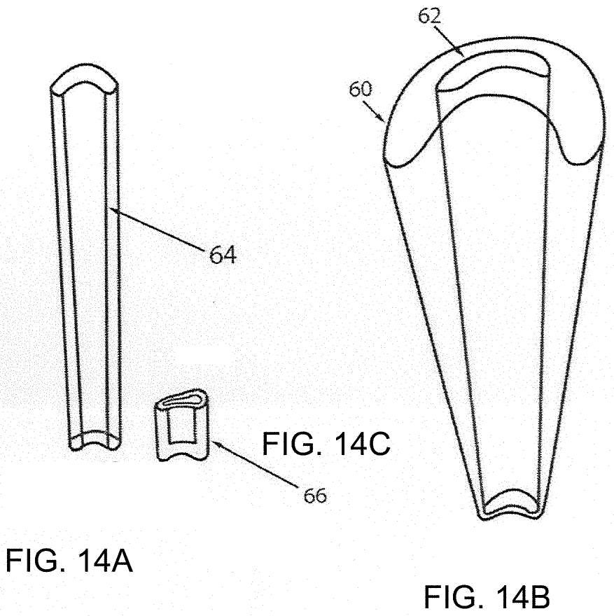

While the GP on filler material can be applied to the typical tooth in a straight forward manner, the situation is somewhat different for a C section uni-canal tooth 60 as shown in FIG. 14B. As shown in FIG. 14B this tooth has a crescent shape with a similarly shaped interior chamber 62. Thus, to accommodate this unusual shape, a C section ultrasonic/thermal curved filler 64 is provided as shown in FIG. 14A. A GP for the apical end of the C section tooth is AC-GP piece 66 as shown in FIG. 14C.

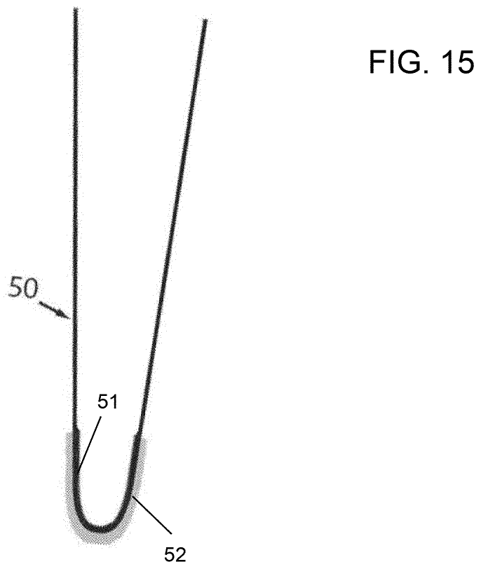

FIG. 15 shows a NiTi filler 50 which has a Teflon non-sticking coating or ultra smooth surface 51 at the apical end. The A-GP pellet 52 is shown engaging the surface. This surface makes 30 it easier to place the pellet A-GP or CA-GP and then withdraw the filler to receive another pellet or the collar without disturbing the pellet.

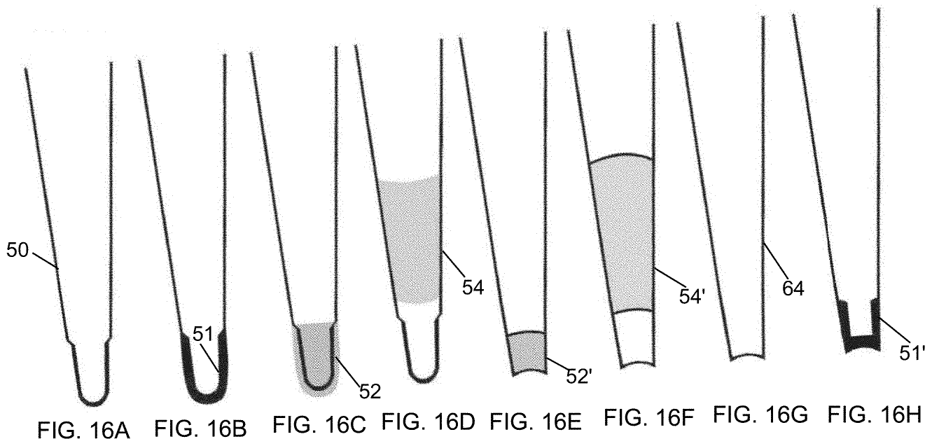

FIG. 16A shows a filler 50 for installing an A-GP piece with an ultra-smooth tip, while FIG. 16B shows the tip of FIG. 16A with a Teflon coating 51. FIG. 16C shows the tip of FIG. 16B with an A-GP pellet 52 on Teflon surface. FIG. 16D shows the tip of FIG. 16A with T-GP material 54 installed. FIG. 16G shows a tool 64 for installing a C section filler with an ultra-smooth tip, while FIG. 16H shows the tip of FIG. 16G with a Teflon coating 51′. FIG. 16E shows the tip of tool 64 of FIG. 16H with a CA-GP piece 52′ for a C section, and FIG. 16F shows the tip of tool 64 of FIG. 16G with CT-GP material 54′.

FIG. 17A shows a filler in the form of a metallic condenser 80, which can be termed a “wood pecker.” The proximal end to the filler 80 is engaged in a tool or hand piece 82, e.g. by a ring retainer, which imparts heat and ultrasonic vibration to it. This heat and vibration energy are transmitted by the filler to any GP mounted on it which causes the GP to flow. In particular, the tool 82 has an ultrasonic vibrator 83 and thermostatic heater 85. The filler 80 passes through an occlusal stopper 84 and into the root canal of the tooth.

The filler 80 has a smooth conical polished tip 87 on which an A-GP pellet 88 is mounted. As an alternative the tip can be coated with Teflon. As best shown in FIG. 17B when heat and vibration are applied to the filler 80, the pellet begins to flow in to the apical canal 72 of root canal formed by tooth apex 70 in order to seal it.

The mid to lower portions of the filler 80 are surrounded by tubular T-GP 86 for sealing side canals 71 of the root 70 forming the root canal as shown in the enlarged view of FIG. 17C. In particular the wood pecker 80 has teeth 81 that aid the GP flow by a hammering motion directing it into the side canals.

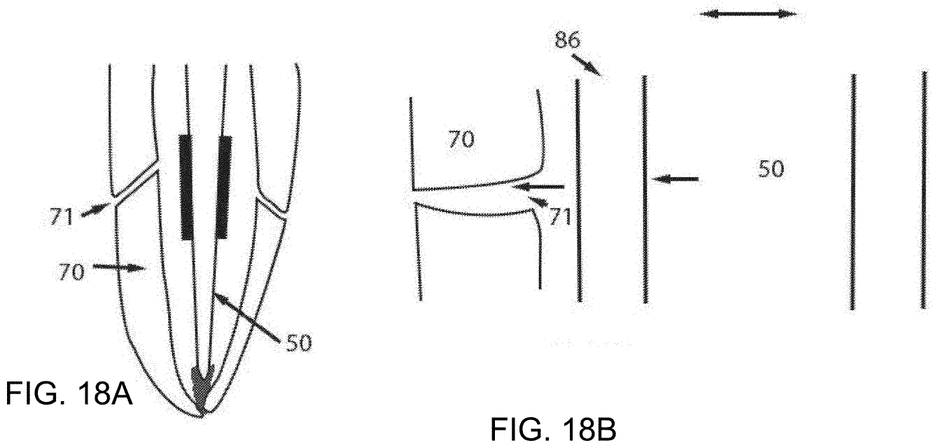

FIG. 18A shows a filler 50 in a root canal formed by root 70. Unlike the wood pecker 80, this filler has a plain surface. Nevertheless, as shown in the enlarged view of FIG. 18B, the T-GP 86 can flow into side canals 71. This is a form of lateral condensation of GP in those side canals or thermal filling of those canals.

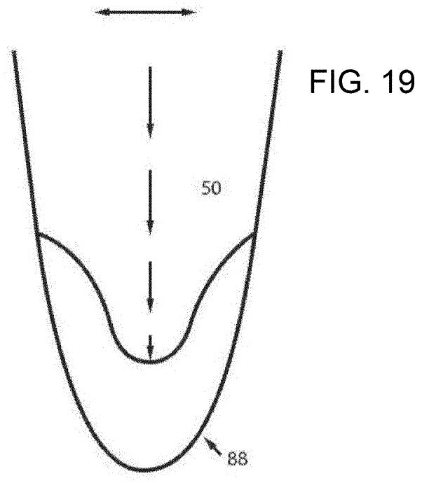

FIG. 19 is an enlarged view of the tip of a nitinol filler 50 with a smooth non-stick surface on which is mounted an A-GP pellet 88. Heat and vibration are conducted to the tip, and hence the pellet, by the filler. When the tip is moved down in the canal toward the apical opening the pellet is melted so as to seal the opening. The heat may then be turned off. Once the GP has cooled the filler is withdrawn. Because of the non-stick coating on the tip, the pellet sealing the apical opening is not dislodged. The retention of the pellet is improved by micro surface roughness prepared by the diamond abrasive tail 22 of the RF Hybrid 20. See FIG. 2A.

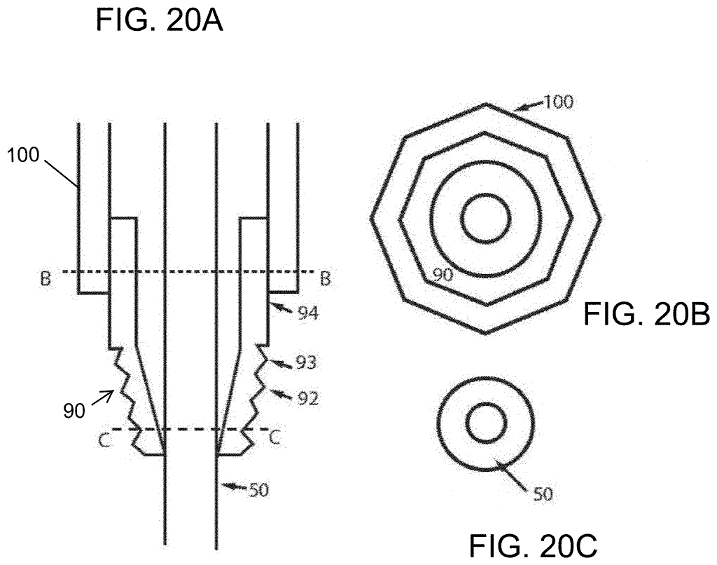

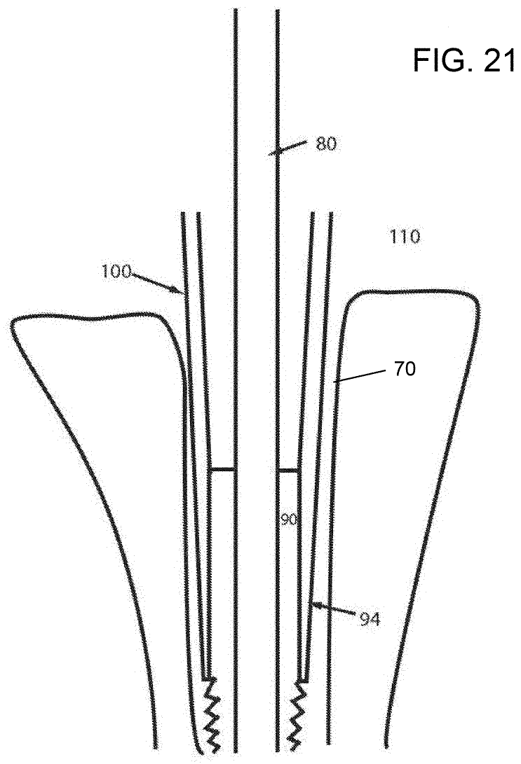

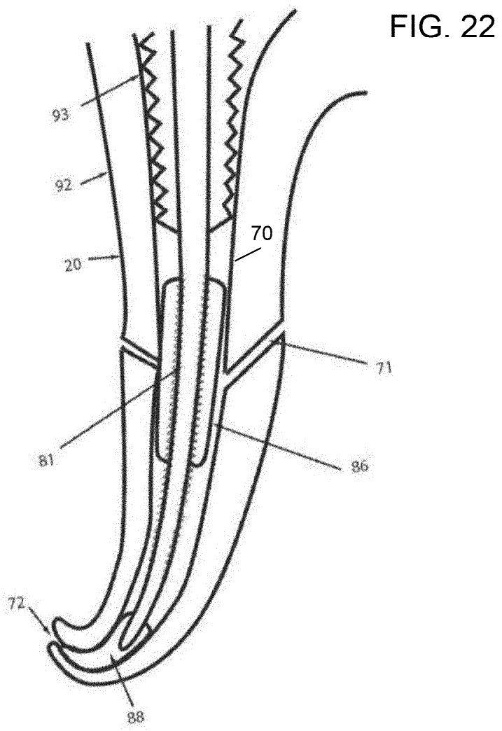

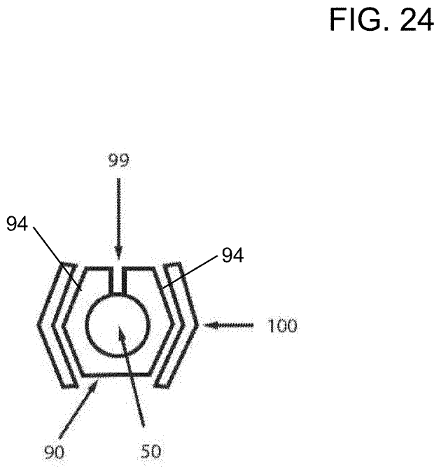

The purpose of a root canal procedure is to remove the decayed pupal and nerve tissue and replace it with an inert filler with a perfect seal. Ultimately the tooth is to be returned to function. To accomplish this, material is built up on top of the canal to support a crown. FIG. 20A shows a side view of an anchorage screw post 90 installed on top of the canal and surrounding the nitinol filler 50. Screw 90, which may be made of stainless steel, has a tubular shape and fits over the filler 50. Screw 90 has a tapered lower section 92 with threads 93. The upper portion has a hexagonal head 94 as can be seen more clearly in the cross-sectional view of FIG. 20B. During installation, this head 94 can be engaged by a hexagonal screw driver or forceps 100 and threaded into the top of the root canal as seen in FIG. 21. A cross section of the forceps can be seen in FIG. 24. The cross-sectional view of FIG. 20B is at line B-B in FIG. 20A. A further cross section is shown in FIG. 20C, which is taken at line C-C in FIG. 20A and shows the threading.

FIG. 21 shows the top and FIG. 22 shows the bottom of an assemblage of the A-GP 88, a nitinol wood pecker filler 80, the T-GP, and the anchor screw post 90 in the root canal cavity formed by root 70. Starting from the bottom of FIG. 22, there is the A-GP pellet 88 which is at the end of nitinol wood pecker filler 80 and seals apical canal 72. The filler 80 also supports collar or tubular T-GP 86, which fills the side canals 71 with the assistance of the wood pecker teeth 81. Above the T-GP there is the tapered portion 93 of the anchorage post screw 90, which has been manually threaded into root canal 70.

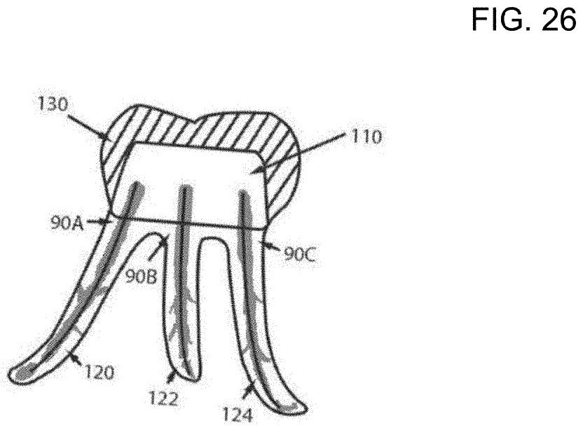

As shown in the bottom of FIG. 21, the top section 94 of the anchor post screw 90 has its hexagonal sides engaged by forceps 100 so it can be threaded into place. Once the forceps are removed, the space above the screw 90 is filled with an amalgam to build the core 110. If a crown is to be placed above the screw as shown below in FIG. 26, the upper section of the remaining tooth 70, amalgam core 110 and filler top 80 are designed to be cut to appropriate height. The top of FIG. 21 indicates that heat and ultrasonic vibration can be applied to the filler during the installation of the GP as described above.

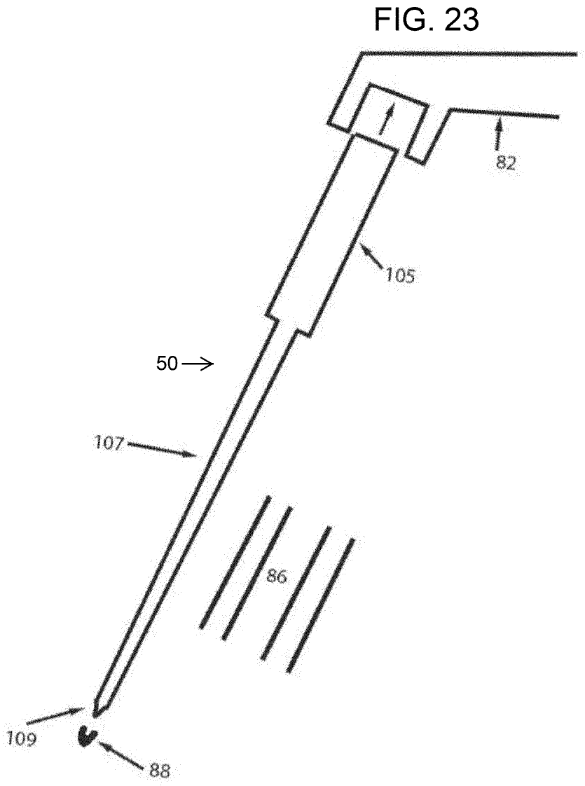

FIG. 23 shows the shape of the nitinol filler 50. At the proximal end 105 it has a cylindrical shape that allows it to be engaged by the hand piece 82. This may be a frictional engagement. Below the end 105 in the distal direction the filler has a tapered section 107. The mid to lower portion of section 107 accommodates the T-GP 86 and the distal end. The apical tip accommodates the A-GP pellet 88. The T-GP material can be in various sizes in order to seal the side canals. Also, the filler 50 can have an ultra-smooth mini holder (optional Teflon coating) 109 at its apical end to secure the A-GP pellet 88.

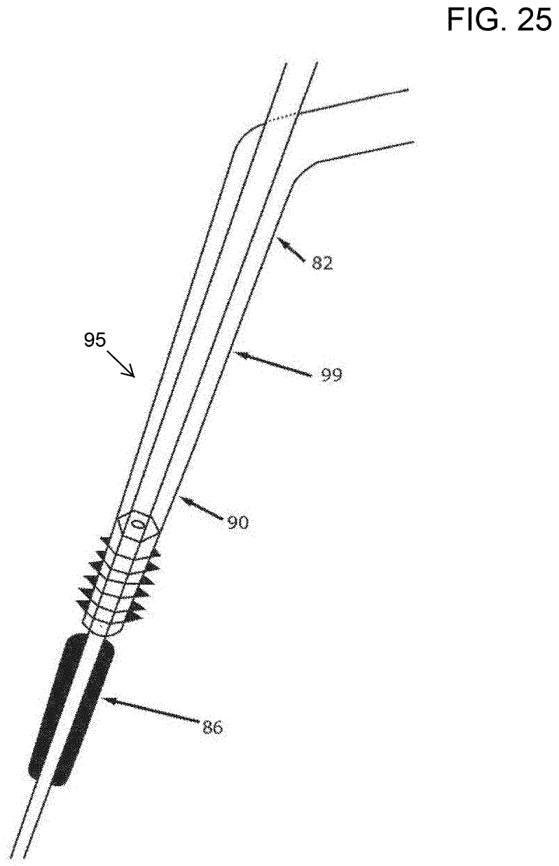

FIG. 24 is a top view of the anchorage screw post 90 with the hexagonal forceps 100 engaging the hexagonal top portion 94. Clockwise rotation of the forceps causes tightening or threading of the threads 93 (FIG. 22) of the screw into the inner root of the tooth at the root canal. FIG. 25 is a perspective view showing a hexagonal screw driver 95 that can be used to tighten screw 90 so that its threads can engage the root canal 70. In FIGS. 24 and 25 there is a slot 99 defined as an eye ruler or ruler window to allow the endodontist to see the ruler markings printed on the filler. The ruler window is provided to allow the dentist to visualize whether the nitinol filler has reached the desired depth.

In FIG. 26 there are shown three stainless steel screw posts 90A, 908 and 90C extending from three neighboring root canals 120, 122 and 124, respectively. Amalgam core material 110, as described with respect to FIG. 21, is filled in, around and between all three posts so they act as a tripod platform and establish a strong well anchored metal core. Once this has been established, a crown 130 is located on top of the amalgam core.

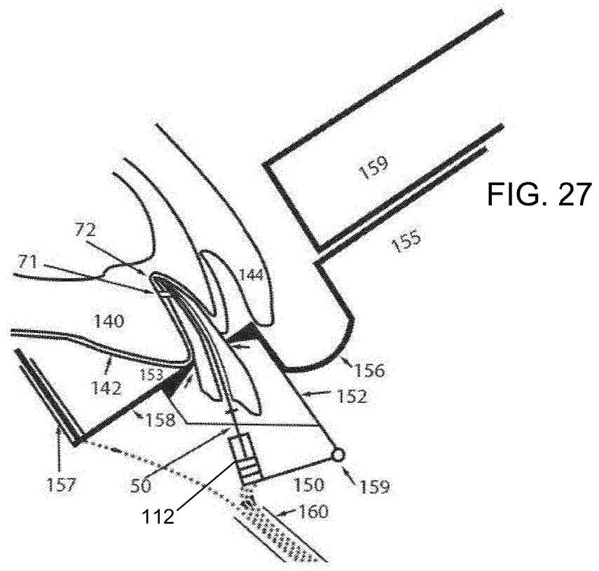

FIG. 27 shows an assemblage of a tool to perform a root canal procedure with a digital x-ray guider and receiver attached so as to provide real time images as the GP is injected in a root canal. In order to provide orientation, a tooth with root canal 70 is shown installed in the upper jaw bone 140 of a patient. The mucosa 143 extends over the jaw bone and a lip 144 defines the outside of the patient's mouth. The tooth has a root canal into which GP filler is being installed.

A tool 150, which may be made of plastics material for thermal insulation and X Ray compatibility engages a nitinol filler 50 which is inserting A-GP at the apex 72 of the root canal and T-GP at the side canals 71. The tool has a mini linear actuator 112 which allows the filler mounted with GP to be pushed into the canal, a mini ultrasonic vibrator that can vibrate the filler either vertically or horizontally and a mini thermal heater that can heat the filler. In this embodiment the tool 150 has a plastic coil spring clamp 153 that clamps it onto the tooth 70. Once it is clamped on, it can be tightened by knob 154. Further tool 150 has a brace 156 that leads to a tubular x-ray guider 155 on one side (e.g., the outside) of the tooth and a brace 158 that leads to a digital x-ray receiver 157 on the opposite side (inside) of the tooth. An x-ray emitter or transmitter 159 is located on the guider 155. When the transmitter is activated, the x-rays pass through the tooth and are captured by the receiver 157. In this case, the receiver is an electronic digital device that electronically forms the image in the computer. As a result, a series of pulse interval x-rays can be taken in real time. The GP and nitinol are visible in the x-rays due to the x-ray opacity of these materials as they move along the canal pathway. As a result, the endodontist can continuously monitor their location in the root canal.

Because the taking of multiple x-rays can be harmful to the dentist, the dentist may be located in a remote room. In such a case, the x-ray images can be passed in a signal line through cable 160 to the remote room where the dentist can view them on a monitor, e.g., a monitor of a computer control system that remotely controls the tool 150. Thus, controls for thermostatic heat, ultrasonic vibration and linear motion would also be provided in the remote room and would be accessible through signal cable 160. As a result, the real time x-ray imaging can be used to provide a robot-assisted application with remote control. Pulse digital X Ray at interval timing has very low radiation dosage, not harmful to the health of the patient.

The endodontist can use a computer to control the real time GP flow imaging by asking the patients to bite on a custom designed x-ray holder. The dentist can then sit inside the remote monitor room to avoid the x-ray radiation and look at the monitor. The software allows for magnification of the images on the computer screen or monitor so that the dentist can see void spaces as they are filled by the GP flow. Based on the monitor images, the endodontist controls the movement of the GP Flow by activating the linear actuator device. Further the endodontist can control the thermostatic temperature and ultrasonic vibration applied to the filler.

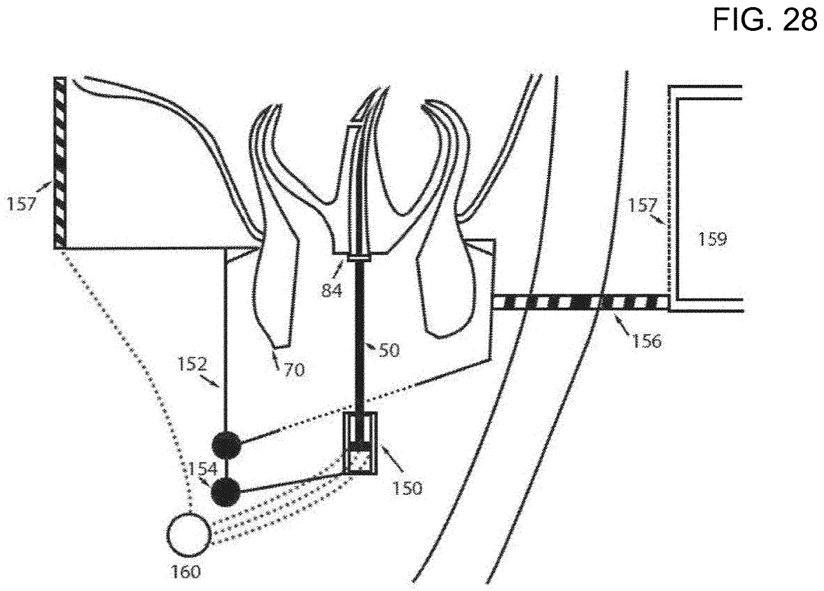

FIG. 28 is an enlarged view of FIG. 27, but with a molar 70A having three apical tips with one being sealed while x-ray images are taken with x-ray transmitter 159 and receiver 157. The signals are passed to the remote room through cable 160. The tool 150 is clamped onto the molar and control signals for it also pass into cable 160.

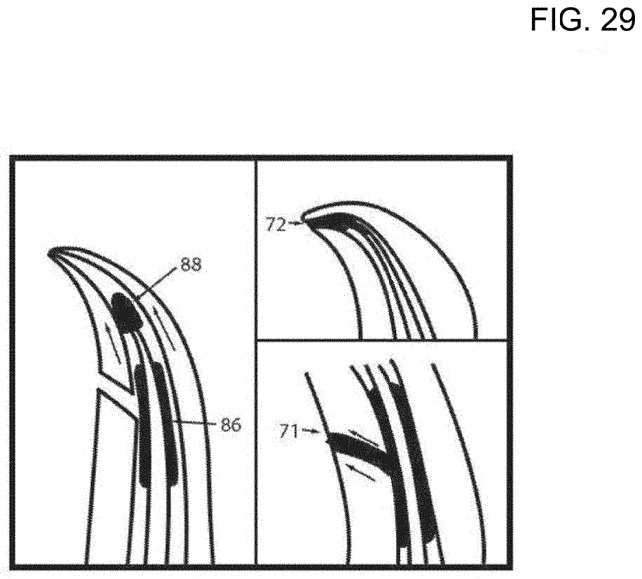

FIG. 29 is an illustration of a computer monitor showing the real time images available during sealing of the tip and side channels, with control of the temperature, vibration and the linear actuator. This is a view of what the dentist might see in the remote control room which would allow control over the procedure remotely.

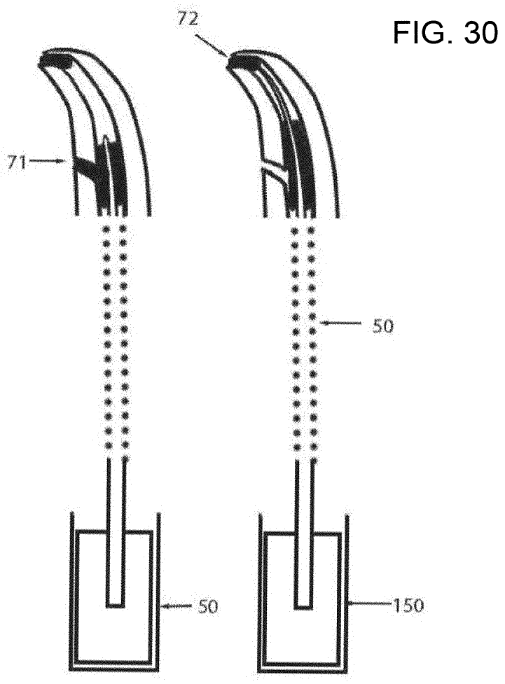

The operation of the linear actuator is shown in FIG. 30 in various states during placement of GP as well as control of temperature and ultrasonic vibration.

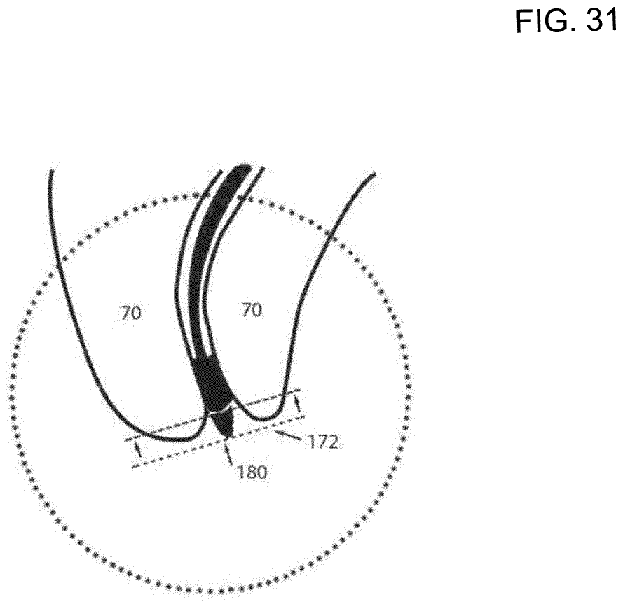

When the A-GP pellet is placed it is warm and flows due to heat and vibration. As it cools there is some shrinkage. FIG. 31 illustrates a computer monitor in which an image of a stop line 180 is provided. This stop line accounts for the volumetric shrinkage of the A-GP pellet 88 after placement, i.e., it is beyond the optimal location, but when the pellet shrinks, it will be at the optimal location. This stop line 180 can be used to trigger the automatic stopping of the linear actuator so as to accurately place the A-GP pellets as part of the computer control automatically. In particular, a finishing stop line 180 can be used in the software to stop the actuator at a point where the GP flow takes into account the volumetric shrinkage of GP, so that the GP is located accurately at the apex 72 after the heat has dissipated. The plotting can be done by a touch screen method.

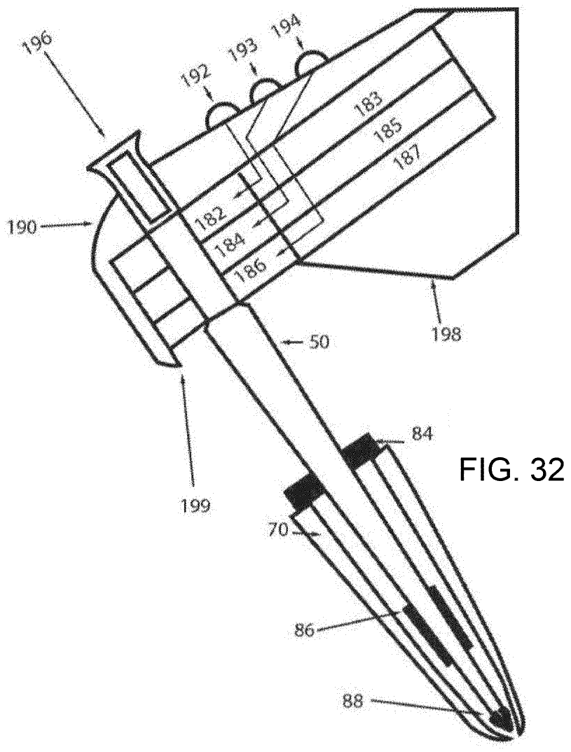

FIG. 32 shows the top and FIG. 32 shows the bottom of an assemblage of a tool 190 for placing a nitinol filler 50, T-GP 86 and A-GP 88, wherein the tool has thermostatic heat and ultrasonic vibration controls. This could be an embodiment of the tool 82 of FIG. 17A or 150 of FIG. 27 or some other embodiment. As can be seen primarily in FIG. 32, the tool engages the upper end of the filler 50. It has at least three transduces 182, 184 and 186. Transducer 182 couples heat from a thermostat 183 to the conductive nitinol filler 50. In order to protect the rest of the tool and surrounding material from the heat, a heat protector 199 is provided at the location of the transducer.

Transducer 184 couples transverse ultrasonic vibration from a vibrator 185 to the conductive nitinol filler 50. Likewise, transducer 186 couples vertical ultrasonic vibration from a vibrator 187 to the conductive nitinol filler 50. Desired temperature and vibratory frequency are under hand control and LED lights 192, 193, 194 on the top of the tool indicate their activation. A button 196 is directly coupled to the filler 50. By pressing the plastic button 196 the filler can be manually removed from the handpiece. Power for the tool is provided by battery 198.

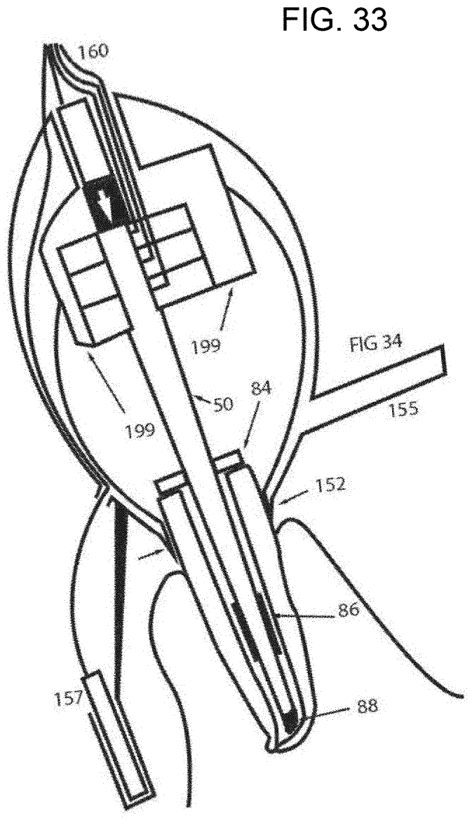

FIG. 33 the assemblage of FIG. 32, further being rotated to show the x-ray guider 155 and receiver 157, and including tooth clamp 152.

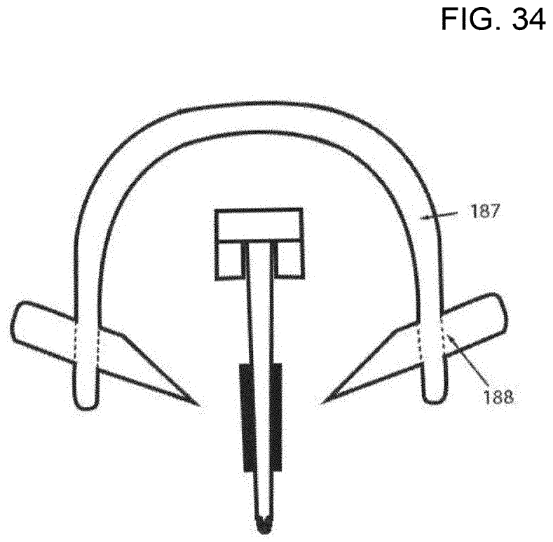

FIG. 34 shows the Dome 187 inserted into the two holes of existing Rubber Dam Clamp 188 for anchorage.

With the present invention the dentist can, for the first time in Endodontics, determine the temperature and vibratory force to control the GP flow in order to reach the terminus points. The dentists can see real time GP flow on a computer monitor due to the opacity of GP motion along the canal pathway.

While the present invention has been particularly shown and described with reference to preferred embodiments thereof; it will be understood by those skilled in the art that various changes in form and details may be made therein without departing from the spirit and scope of the invention, and that the embodiments are merely illustrative of the invention, which is limited only by the appended claims.

We claim:

1. A process for sealing the ends of channels in a root canal of a tooth, comprising the steps of:
providing a Gutta Percha (“GP”) pellet;
installing the pellet at the apical tip of the channel;
providing a GP collar:
installing the collar about the side walls of the channel distal of the apical end.

2. The process of claim 1 wherein the step of installing involves placing the GP on tapered nitinol filler that fits within the channel.

3. The process of claim 2 wherein the filler selectively applies thermostatic heat to the GP during installation.

4. The process of claim 2 wherein the filler selectively applies ultrasonic vibrations to the GP during installation.

5. The process of claim 3 wherein the filler further selectively applies ultrasonic vibrations to the GP during installation.

6. The process of claim 2 wherein the filler has a Teflon coating or ultra smooth surface at its apical end and the GP engages the Teflon coating or ultra smooth surface.

7. The process of claim 1 further including the step of providing real time x-ray images of the root canal during installing of the GP in order to guide its placement.

8. The process of claim 1 further including a tool for providing linear movement to the filler and at least one of thermostatic heat and ultrasonic vibration during the installing steps.

9. The process of claim 8 further including the step of providing real time x-ray images of the root canal during installing of the GP in order to guide its placement.

10. The process of claim 9 wherein the linear movement and at least one of thermostatic heat and ultrasonic vibration are controlled remotely and x-ray images are viewed remotely.

11. An apparatus for sealing the ends of channels in a root canal of a tooth comprising:
a tool that engages a filler, said tool being capable of imparting longitudinal motion to the filler to move it into and out of the canal, said filler being able to carry a a Gutta Percha (“GP”) pellet at its distal end and a GP collar about its lower end;
a spring coil clamp on the tool that allows the tool to be clamped onto the tooth;
an x-ray guider supported on the tool so that an x-ray transmitter in the guider directs x-ray though the tooth; and
an x-ray receiver supported on the tool so that x-rays that pass through the tooth and are captured by the receiver as x-ray images; whereby a series of x-rays can be taken in real time revealing the location of the GP and filler during motion of the filler.

12. The apparatus of claim 11 wherein the tool is further capable of imparting at least one of ultrasonic vibrations, either vertically or horizontally, and heat to the filler.

13. The apparatus of claim 11 wherein the filler is made of nitinol.

14. The apparatus of claim 12 wherein the longitudinal motion, vibration and thermostatic heat can be remotely controlled.

15. The apparatus of claim 14 wherein the remote controls are located in a remote-control room and the x-ray images are passed to a monitor in the remote-control room.

16. The apparatus of claim 14 wherein the GP pellet is heated by the tool as it is placed and
the longitudinal motion is controlled by a computer through a software module that establishes a finishing line, such that during placement of the GP pellet at the apical tip of the root canal, it stops the longitudinal motion at a point authenticated by x-ray images that takes into consideration shrinkage of the pellet as it cools.

17. A filler for use in root canal procedures comprising a tapered body of a size such that it can fit within the root canal of a human tooth, said tapered body having a necked-in region at a mid-section thereof such that the body has an isthmus design with an upper portion of the tapered body proximal of the necked-in region and a lower portion distal of the necked-in region, said body also having a tip at its distal end adapted to carry an apical GP pellet and place it at an apex of the root canal, an upper portion of the body proximal of the necked-in region being adapted to carry a tubular GP sleeve and place it adjacent side canals of the root canal, said tapered body being strong enough to withstand and transmit ultrasonic vibration, said tapered body being made of a material that transmits heat, and the material of said tapered body at least in the area of the necked-in region and the cross-sectional size of the necked-in region being such that rotation of the upper portion with respect to the lower portion will cause the body to break into separate upper and lower portions.

18. A process for sealing the ends of channels in a root canal of a tooth, comprising the steps of:
using a filler with a necked-in region at a mid-section thereof such that the body has an isthmus design with an upper portion proximal of the necked-in region and a lower portion distal of the necked-in region to place an apical Gutta Percha (“A-GP”) pellet at an apex of a root canal;
applying heat to the A-GP through the filler until the A-GP melts and flows to a finishing stop;
removing the heat an allowing the A-GP to solidify;
twisting the upper portion of the filler until it breaks at the necked-in region;
leaving the lower portion in place in the root canal and withdrawing the upper portion from the root canal;
installing a tubular Gutta Percha (“T-GP”) sleeve about the upper portion of the filler;
reinstalling the upper portion of the filler into the root canal adjacent side canals thereof:
applying heat and ultrasonic vibration to the T-GP through the upper portion of the filler until the T-GP melts and flows into the side canals; and
removing the heat and vibration.

19. The process of claim 18 wherein the filler is made of NiTinol.

20. The process of claim 18 wherein the upper portion is left in place after the procedure.
